(19) United States
(12) Patent Application Publication
(10) Pub. No.: US 2023/0230051 A1
(43) Pub. Date: Jul. 20, 2023

(54) SYSTEM AND METHOD OF USING BILL OF MATERIALS (BOMS), COMPONENT USAGE METRICS AND ENVIRONMENT METRICS TO OPTIMIZE EWASTE AND ATTAIN SUSTAINABILITY GOALS

(71) Applicant: Dell Products L.P., Round Rock, TX (US)

(72) Inventors: Nicole Reineke, Northborough, MA (US); Eloy Francisco Macha, Las Cruces, NM (US); Alan Sevajian, Salem, NH (US); Robert Alan Barrett, Austin, TX (US)

(21) Appl. No.: 17/648,512

(22) Filed: Jan. 20, 2022

(51) Int. Cl. G06Q 10/00

(52) U.S. Cl. CPC G06Q 10/30

(57) ABSTRACT

One example method includes for an electronic asset that includes hardware, creating an asset record that includes information about a physical configuration of the electronic asset and materials included in the electronic asset, entering the asset record in an electronic waste tracing datastore, at an end of a useful life of the electronic asset, or a component of the electronic asset, performing an inquiry to identify options for disposition of the electronic asset or a component of the electronic asset, receiving a user selection of one of the options, and based on the user selection, performing the selected option with respect to the electronic asset or the component of the electronic asset.

### FIELD OF THE INVENTION

Embodiments of the present invention generally relate to systems and methods for dealing with electronic waste (eWaste). More particularly, at least some embodiments of the invention relate to systems, hardware, software, computer-readable media, and methods for creation and use of a sustainability-focused asset reclamation system that enables intelligent eWaste-aware decision making.

### BACKGROUND

Existing infrastructure management solutions do not account for reductions in, and reclamation of, so-called eWaste, that is, electronic equipment such as computers, peripherals, and other hardware. Instead, companies are required to create manual accounting and reporting of assets and, as a result, opportunities for upcycling, reuse, donation, and preventing items from becoming eWaste, are missed. These missed opportunities may increase expenses for the company, contribute to inefficient use of resources, clog landfills, and exacerbate supply chain problems.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example system and method for identification, handling, and disposition of eWaste.

FIG. 2 is a screenshot that discloses aspects of an example sustainability platform.

FIG. 3 is a screenshot from an example sustainability platform that discloses various user options, and associated impacts, regarding a component under consideration for decommissioning.

FIG. 4 is a screenshot displaying elements of an example reporting mechanism for eWaste data.

FIG. 5 discloses aspects of a computing entity operable to perform any of the disclosed methods, processes, and operations.

### DETAILED DESCRIPTION OF SOME EXAMPLE EMBODIMENTS

Embodiments of the present invention generally relate to systems and methods for dealing with eWaste. More particularly, at least some embodiments of the invention relate to systems, hardware, software, computer-readable media, and methods for creation and use of a sustainability-focused asset reclamation system that enables intelligent eWaste-aware decision making.

In general, example embodiments of the invention may perform a variety of operations. One of these is leveraging already available BOM (bill of material) and component data for all hardware assets in a customer system. This may include capturing all sustainability specifications for each component, and whole systems, as applicable to each sustainability metric. Example embodiments may also leverage a measurable set of sustainability goals and policies. The sustainability goals/policies may be defined/provided by any organization, by a government, and/or by a compliance agency. As well, embodiments may leverage a secondary data set for the identification of material reuse opportunities. An example secondary data set may include, for example, product and component specifications with regards to MTBF (mean time between failures), and longevity based on set use-patterns. Finally, an embodiment may leverage a further secondary set of data for external organizations and needs identification. An example of this set of data may include metrics of system and component actual usage throughout lifetime, such as power, environmental conditions such as thermal load, noise and vibration, frequency, uptime, downtime, and other metrics impacting longevity.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may provide for systems and methods for eWaste aware decision making at various stages in the lifecycle of a hardware component. An embodiment may provide for eWaste aware decision making at an enterprise level. An embodiment may employ component specific metrics and environmental metrics to reduce, or minimize, eWaste, and to meet sustainability goals. An embodiment may reduce unnecessary consumption and waste of hardware resources. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Current Challenges

Following is a discussion of problems that may be resolved, or avoided, by example embodiments. This discussion is not intended, nor should be construed, to limit the scope of the invention in any way.

In general, eWaste is a massive, uncontrolled problem. However, current infrastructure approaches disconnect reclamation and return cycles from the use and management of assets. The traditional focus has been to accomplish a ‘bulk’ approach of limiting the amount of eWaste from going to landfills, but fails to address recyclable opportunities in a scalable or efficient manner.

Further, there is no easy way to measure, and track, usage of a discreet component within sustainability values during a right to repair incident. Multiple components integrated into a system, such as the various components included in a server for example, are not tracked from a sustainability point of view. Existing approaches for right to repair incidents lack insight into what are the sustainability measurements, such as component carbon footprint, longevity, and reusability, of the discreet components.

Another challenge concerning eWaste is that there is no ability to audit organization decisions at an individual component level, such as based on sustainability values and usages for example. Instead, typical approaches emphasize a macro, or organization-wide, view of system sustainability metrics, and use-patterns are typically employed by organizations to address high-level sustainability decisions. From an audit perspective, there is no process or way to track/trace down to a discreet component(s) in a single system or across multiple systems, and assess their individual respective impact on sustainability.

Further, there is no practical way to automate and identify reuse opportunities that are aligned with the sustainability goals of a company. Currently, organization sustainability goals are typically focused on an abstracted view of carbon footprints. In contrast, example embodiments may expand the ability to understand and make informed decisions that reach beyond product carbon footprint (PCF) to address/impact other sustainability opportunities like keeping products out of the eWaste stream through upcycling and reuse of products and componentry. This approach of example embodiments may greatly enhance the ability of an organization to meet wider sustainability goals.

A further challenge is that there is presently no practical way to adhere to geofencing considerations and abide by environmental compliance requirements within a given geography as related to systems and components used within that geography by a customer/organization. Particularly, organizations will need to start complying with environmental and government regulatory agencies which have governing authority at national and regional/state level. These regulations may introduce net-new sustainability goals within a region that differs from other regions an organization operates in. These differences may cause sustainability goals/objectives to require different methods of action. For example, California does not allow devices that consume a certain level of power to be sold in that state, regardless of the larger carbon footprint of the device and the device lifecycle. In this geography-specific example, an organization would have to use a different asset type to meet the organizational goals where the geographic location is physically in CA.

Finally, there is no practical way to provide proof of reclamation of assets for use in reporting that is required by government and industry mandates. At some point however, organizations will need to start complying with additional environmental and government regulatory agencies regulations such as reclamation of assets. This introduces a new level/layer of auditing/tracking for which organizations will now have to demonstrate their adherence, such as by reclamation of assets, or performance of other e-Waste reduction actions.

### B. Overview

A number of organizations have internal goals requiring that the company take sustainability into account in its infrastructure practices such as purchasing, use, repair, and disposal. Additionally, government programs are emerging that require organizations to comply with varying and conflicting outcomes, from eWaste management to power consumption to social and even economic variables.

Thus, example embodiments may enable the components of sustainability to inform the specification, repair, reuse, and disposal, of systems, components, re-homing of systems and components, and may also enable the traceability of system and component reclamation in support of reporting requirements, use in government and private refund programs, and fine avoidance. Example embodiments may enable and implement such functionalities by various mechanisms and approaches.

For example, embodiments may leverage already available BOM and component data for all assets in a customer system. This approach may include capturing all sustainability specifications for each component, and whole systems, as applicable to each sustainability metric. As another example, embodiments may operate to leverage a measurable set of sustainability goals and policies. Such sustainability goals/policies may be defined/provided by any organization, by government, and by compliance agencies. Further, example embodiments may leverage secondary data sets for material reuse opportunity identification. Such data sets may include data concerning product and component specifications with regards to MTBF, longevity based on set use-patterns, for example. Finally, embodiments may leverage a secondary set of data for external organizations and need identification. Such a data set may include, for example, metrics of system and component actual usage throughout lifetime, such as power, thermal, frequency, and other metrics impacting longevity of a device, system, or component.

Thus, embodiments may operate to quickly identify infrastructure needs where a range of electronics and other hardware, from an entire system to a single subcomponent, may be reutilized, upcycled, or donated, as dictated by the sustainability goals/policies of an organization. Where such approaches are not possible, or practical, embodiments may operate to identify reclamation opportunities, and to create a detailed asset accounting report for use in supporting government and industry mandated programs and compliance processes.

### C. Detailed Aspects of Some Example Embodiments

### C.1 Example System

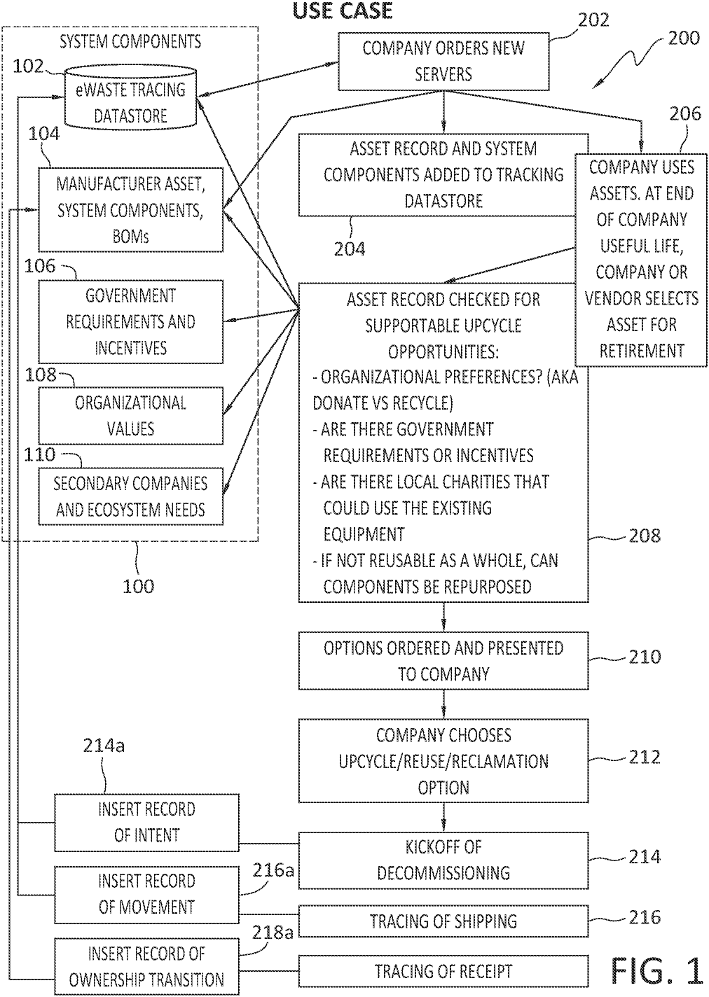

At a basic level, example embodiments are directed to a sustainability-focused asset reclamation system that enables eWaste-aware decisions. With reference now to FIG. 1, some embodiments may achieve this through the use of a system 100 that comprises the components disclosed in FIG. 1. Additional and/or alternative components may be used in some embodiments.

As noted in FIG. 1, the system 100 may include an eWaste tracing datastore 102 that may be employed to hold all asset component tracing and user decision in a Historian. The eWaste tracing datastore 102 may be accessible for use in reporting, and exporting, data as proof of reclamation and/or for other purposes. Depending upon the embodiment, the eWaste tracing datastore 102 may be specific to a particular organization, or may be a hosted database where multiple organizations store their respective asset records and other information.

The example system 100 may further include manufacturer asset and system component bills of material (BOM) dataset 104, or simply ‘dataset 104.’ In general, the information in the dataset 104 may serve as a secondary data source that may provide a complete accounting of asset components as-shipped to a customer, or used by a customer in hosted instances. The dataset 104 may also include sustainability aspects of component configuration, power demands of the component, and PCF. More generally, any feature or characteristic of a component or system that implicates an issue related to sustainability may be included in the dataset 104. The dataset 104 may be stored in the eWaste tracing datastore 102.

The system 100 may additionally comprise a government requirements and incentives dataset 106, or simply ‘dataset 106.’ In some embodiments, the dataset 106 may comprise a compiled list of documented requirements by external regulators such as government agencies for example, and/or internal regulators of an organization, concerning the specification, reclamation, repair, refurbishment, reuse, disposal, and/or donation, of assets. The dataset 106 may be stored in the eWaste tracing datastore 102.

With continued reference to the example of FIG. 1, the system 100 may include an organizational values control plane 108. In general, the organizational values control plane 108 may operate to (1) compile sustainability values for one or more components or systems, as they are selected by a service provider or vendor, organization, or individual, resulting in a complete inherited sustainability value for the component or system, (2) compare resulting recommendations, which may be based on the sustainability values, against sustainability SLIs (service level indicators) and secondary data sources, and then (3) perform, based on the comparison, a tradeoff analysis to ensure that minimum sustainability standards are met for each system and component.

Finally, the example system 100 may include a list 110 of secondary companies and ecosystem needs. By way of comparison, many major organizations maintain a list of acceptable non-profits and local charities. The list 110 may include not only such non-profits and charities, but also a set of known workload or asset requests or requirements so that organizations can donate systems and components based on the needs of a charity. In this way, the lifecycle of componentry may be extended while maintaining alignment and compliance with organizational goals regarding eWaste. The list 110 may be stored in the eWaste tracing datastore 102.

### C.2 Example System Operations

With continued attention now to FIG. 1, details are provided concerning an example method 200 that spans the lifecycle of an asset from the time of procurement through final disposition. The example method 200 may be performed, for example, in whole or in part by an organization that has a need for, and uses, hardware that may, at the end of its lifecycle, become eWaste. Further, the example method 200 may be implemented by a system, such as the system 100, that may be located at an organization. In some instances, the example method 200 may be provided aaS (as a service), such as by a vendor of the hardware for example, to one or more subscribers, such as a purchaser/user of the hardware for example. No particular implementation, nor system for implementation, of the method 200 is required however.

The example method 200 may begin at 202 when an organization places an asset order with a vendor which then fulfills the order. An asset may comprise one or more components. The asset may be for local use by the organization, or may be employed in a hosted environment accessible by the organization. The organization may generate 204, possibly automatically based on asset configuration information included in the purchase order, an asset record. The asset record may include a complete bill of materials and a listing of sub-componentry. The asset record may be added to the eWaste tracing datastore 102. Asset records in the eWaste tracing datastore 102 may be sorted, and reported upon, any bases or fields of the asset record. Depending upon the embodiment, the eWaste tracing datastore 102 may be a privately hosted datastore, hosted by the organization that ordered the asset for example, or the eWaste tracing datastore 102 may be hosted by a vendor. For industries or government organizations that may require an immutable record, the asset records may be stored as a ledger, such as a blockchain ledger for example.

The scope of the invention is not limited to any particular type of asset record, nor to any particular collection of information in a data record. One example of an asset record may include, as a minimum in some embodiments, the following fields/information: OrderingCompanyName; AssetID; VendorName; AssetName; AssetSubcomponent (Array); AssetBehaviorTags (which may comprise optional descriptors for easier matching); and, a VendorReclamationServicesLink. Other fields in an asset record may identify, for example, type and amount of known hazardous materials included in the asset, and the country where the asset and/or its subcomponents was manufactured.

A secondary table may be provided in the eWaste tracing datastore 102 that includes the OrderingCompanyName of the organization that ordered the asset, and links the organization with, for example, databases such as GovernmentRegulationsFK, and/or OrgValuesFK. The GovernmentRegulationsFK may include information, and government regulations, that pertain, or may, to one or more assets purchased and/or used by the organization. The OrgValuesFK database may be a database internal to the organization that may include information describing a sustainability program and guidelines. As used herein, “FK” generally refers to a Foreign Key.

The eWaste tracing datastore 102 may further include, for each vendor, a table comprising fields and information such as VendorName, ReclamationDetails, which may be in the form of an array, and which may link to a process for asset takeback by the vendor, which may be an upcoming regulatory requirement. Further, manufacturer BOMs, which may be provided at an asset and/or component level, may include fields and information such as, but not limited to: AssetID (specific to asset, vendor, and/or organization); AssetType (such as hard drive, CPU, processor); Components (elements of the asset); ComponentArray (for example, carbon footprint, recyclability, %MaterialRecycled, and power requirements, of a component).

With continued reference to FIG. 1, the organization may use 206 an asset for a period of time, which may be fixed, or open-ended. As the asset componentry wears out, replacements and reclamation may be noted in the eWaste tracing datastore 102. A user may be able to determine the components of any asset as the eWaste AssetID may correspond to the BOM for that asset. The eWaste tracing datastore 102 may also list an asset/component CFP, and/or other sustainability metric(s), and may provide a comparison of the asset/component against any individual asset/component for replacement, and/or the eWaste tracing datastore 102 may provide cumulative asset/component data.

If an organization or vendor determines that an asset is to be retired, the asset may be entered into an asset retirement workflow by the organization or vendor. Where the vendor implements the asset retirement workflow, the vendor may notify, and coordinate with, the organization to implement the asset retirement workflow. In some embodiments, an eWaste tracing service may initiate a reclamation process that comprises a portion of the asset retirement workflow.

Initially, the asset retirement workflow may involve the performance of various inquiries 208 which, among other things, may identify various options that may be available to the organization with respect to the disposition of an asset/component. To illustrate, the eWaste tracing datastore 102 may be checked for asset characteristics. Further, asset/component reuse may be checked for working componentry of the asset. An example of such an inquiry may be: are there any requests for equipment that could be fulfilled met with the asset/components about to be retired? The reuse check may be performed first inside the organization, and then externally with respect to one or more other organizations who may be able to reuse the asset/component.

As part of the initial inquiries 208 concerning disposal of the asset/component, government requirements or incentives checked for specific incentives related to disposal of the component/asset that can be leveraged. For example, the organization may be able to donate the asset/component to charity, the asset/component may contain precious materials that could be reclaimed, and there may be a financial or other incentive to return the asset/component to a specific agency. In some embodiments, a check may be made of a secondary data source that includes information such as geographic location of the asset/component, incentive type, incentive amount, and actions required to qualify for an incentive payment.

The initial inquiry 208 may comprise performing a check with respect to the values of the organization. For example, what has this organization chosen to do, or which sustainability goals is it looking to meet?

In some embodiments, the initial inquiry 208 may determine if there are any charities that may be able to use the asset/component. Donation of the asset/component to a charity may be helpful to the charity, while also providing a tax benefit to the organization that donates the item. In the inquiry 208, if the option to donate to a charity or secondary organization, full system or system component, is returned as a possible option, the system 100 may check the asset/component against the secondary companies and ecosystem needs datastore. If more than one possible match, that is, more than one charity or other organization, is returned as a result of the inquiry, the system 100 may order the results of the query by the highest % of system reuse to the lowest percent. For example, one result may indicate that a particular organization can use the entire asset, while another result may indicate that a charity can only use 1 component of the asset. In this example, the asset may be donated to the organization that can use the entire asset. Various other additional, or alternative, criteria may be employed to guide a donation decision. If no matches are returned, this particular portion of the inquiry 208 may end. As part of a donation inquiry, the method 200 may attempt to match the component known behaviors from a sustainability and mean-time-to-failure using secondary environment data, such as humidity and temperature for example, to choose a likeliest best match based on component-type historical behaviors.

Finally, it may be the case that the inquiry 208 identifies recycling of the asset/component as the only viable option, a response to the inquiry 208 may comprise links to, for example, government recycle incentive programs, and vendor reclamation services. The organization may choose from any of these recycle options.

After the initial inquiry 208 has been performed, and various options for handling of the asset/component identified, the options may be ordered according to any suitable criteria, and presented to the organization 210. In some embodiments, the organization, possibly represented by a user, may choose to filter and/or re-order the options. The user may then select 212 an option for the handling of the component or asset. Such options may include, but are not limited to, upcycle, reuse, or reclamation.

Once the user has made a selection 212, a decommissioning process for the asset/component may be initiated 214, possibly automatically upon selection 212 by the user. In connection with initiation 214 of the decommissioning process, a record of intent to decommission may be inserted 214a into the eWaste tracing datastore 102. Next, shipping labels and associated documentation may be generated to enable tracing 216 of the component/asset that is being decommissioned. In connection with creation of tracking information 216, a record of the movement, in the shipping process, of the asset/component may be inserted 216a into the eWaste tracing datastore 102.

Finally, as part of a tracing process 218, the organization may receive a receipt indicating that an intended recipient of the asset/component has received that asset/component. Correspondingly, a record of the ownership transition may be inserted 218a into the eWaste tracing datastore 102. As part of, or separately from insertion 218a of the record of ownership transition, data concerning the asset/component that is in the eWaste tracing datastore 102 may be made accessible to the new owner, and the asset record updated so that the new owner may include the asset/component in its own eWaste tracing process.

### D. Further Discussion

As will be apparent from this disclosure, example embodiments may possess a variety of useful features. For example, embodiments may employ the use of asset ordering processes and system componentry in IT infrastructure systems to establish asset/component level eWaste Tracing. As well, embodiments may implement data tracing for donation, reuse, or recycling recommendations, based on regulations, organizational values, and preferred charities of an organization. Example embodiments may provide detailed tracing of system componentry within IT infrastructure systems, and tracks macro, and micro, views such as whole system donation, reuse, as well as component donation, reuse, recycling opportunities as defined by organization regulations, values and potentially target charities. This data is then usable for reporting and decision making.

As another example, embodiments may implement and use a historian as an element of an eWaste tracing datastore to record component movement, recycling, reuse, or donation within a sustainability-aware system. The historian may also be employed as a mechanism for reporting, fine avoidance, and to provide data and information to support incentive claims, where such claims may be available through regulations and private opportunities. Further, including the example eWaste tracing system into an organization sustainability-aware system, enables the methodologies to record system and component movements within an organization, and also to record the recycling, reuse and donation decisions. This information may be used, for example, to compile a data audit record that can be used to generate sustainability reports to help avoid fines, take advantage of incentives, and for other activities such as providing transparency to shareholders and other stakeholders of the organization.

Example embodiments may provide the ability to make right-to-repair component level decisions based on sustainability values. Particularly, data from discreet assets/components in each system may be used to make decisions within right-to-repair incidents. This is an area of increasing interest in this field, and embodiments may trace different repair options to a component CPF, and/or a repair option may be based on power consumption implications, for example.

Another feature of some example embodiments is the ability to trace component level decommissioning decisions based on defined sustainability values of an organization. For example, embodiments may provide a process in which sustainability tracing data from discreet component in each system is used to make replacement decisions at the component level, asset level, or system level. This data may be obtained, for example, by accessing vendor BOMs and various secondary data sources.

As another example feature, some embodiments may operate to ingest a secondary data set, which may include information about the physical environment of each organization and assets, and then compare known sustainability/use goals, such as MTBF for example, with other sustainability values, which may not be fully known, of each component in secondary physical environments. More specifically, embodiments may comprise a process to augment eWaste tracing by ingesting data from a secondary data set of physical environments and their impact to system and component level assets based on baseline/known sustainability goals, such as MTBF for example, for a given system and/or component. Secondary data sets may comprise known metrics, such as concerning a physical environment, which may impact MTBF and other sustainability goals. As new sustainability goals and values are identified, the process may allow expansion and ingestion of heretofore unknown data sets in sustainability goals.

Finally, example embodiments may implement geofencing considerations to enhance decisions on components and systems, located within a specific geographic area, in aligning an asset/component disposal decision with sustainability goals/objectives specific to that geographic area. For example, example embodiments may consider, in a disposal or decommissioning process, which regulatory specific sustainability considerations are applied based on the geographical area.

### E. Example Use Case

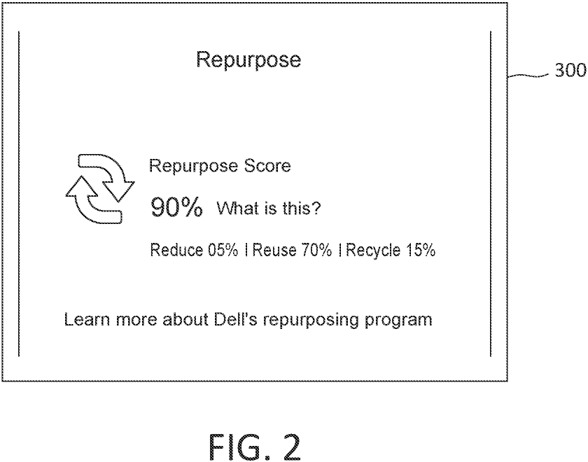

With attention now to FIGS. 2, 3, and 4, details are provided concerning an example use case for example embodiments that involves use of the DellEMC APEX system. This use case is provided for the purpose of illustration and is not intended to limit the scope of the invention in any way.

In this example, a screenshot 300 of an APEX recommendations screen in FIG. 2 displays a repurpose score generated from eWaste data concerning a component that has been, or may be, decommissioned. Particularly, BOM details for the asset and the upcycling component details are used as a basis for generating a repurpose score which may help a user understand the impact of various courses of action that may be taken with respect to the component. In general, a repurpose score, as used in this example, may reflect an extent to which a particular course of action, with respect to an asset/component, makes the best use of that asset/component, as measured against sustainability goals of the organization that owns the asset/component and/or other sustainability measures and requirements. Thus, with reference to the example of FIG. 2, reusing the component is the course of action that best fulfills the sustainability goals of the organization. Recycling the component, while providing some benefit, is substantially less effective in meeting the goals of the organization. Finally, reduction, or simply throwing the component away as eWaste, fails to support the sustainability goals of the organization.

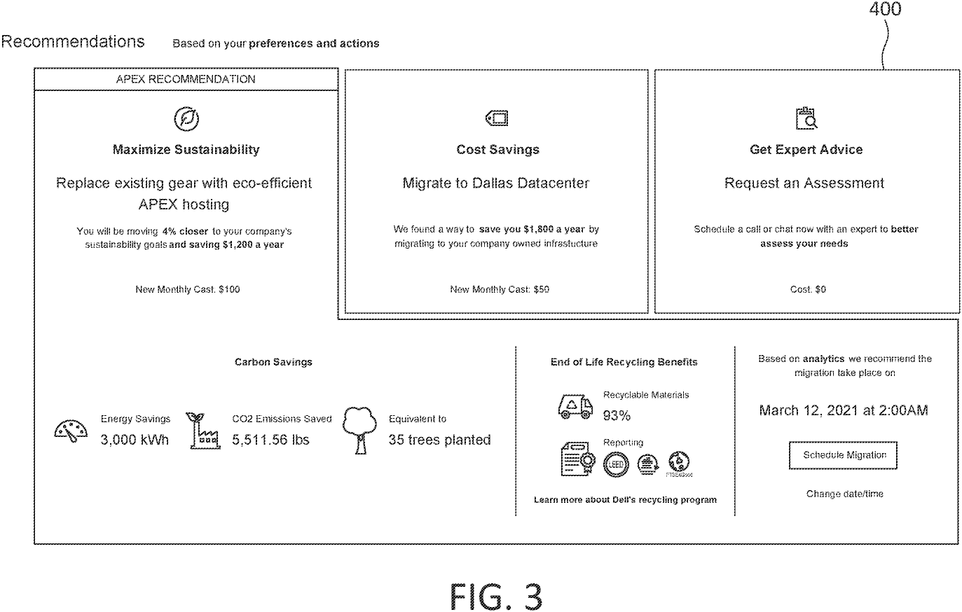

In a secondary screen, a screenshot 400 of which is disclosed in FIG. 3, various recommendations are presented that may be generated based on input received from a user, and/or based on sustainability goals, governmental regulations, and/or other input. This particular example compares the dollar cost of retiring and replacing the component with the dollar cost of moving a function performed by the component to a hosted APEX environment. For any selected option, which is ‘replace existing gear’ in FIG. 3, other impact information may be displayed, such as carbon savings, end of life recycling benefits, and/or other information. In this way, a user can quickly and easily compare and contrast the impact, positive and/or negative, of a particular course of action, such as repurposing, with respect to a given asset/component. While some of such analyses may be performed after a component has reached the end of its service life, ‘what if’ analyses may also be performed when considering the purchase of a new asset/component. In this way, an organization may be able to assess the potential impact of its purchasing decisions before the asset/component is actually brought on line.

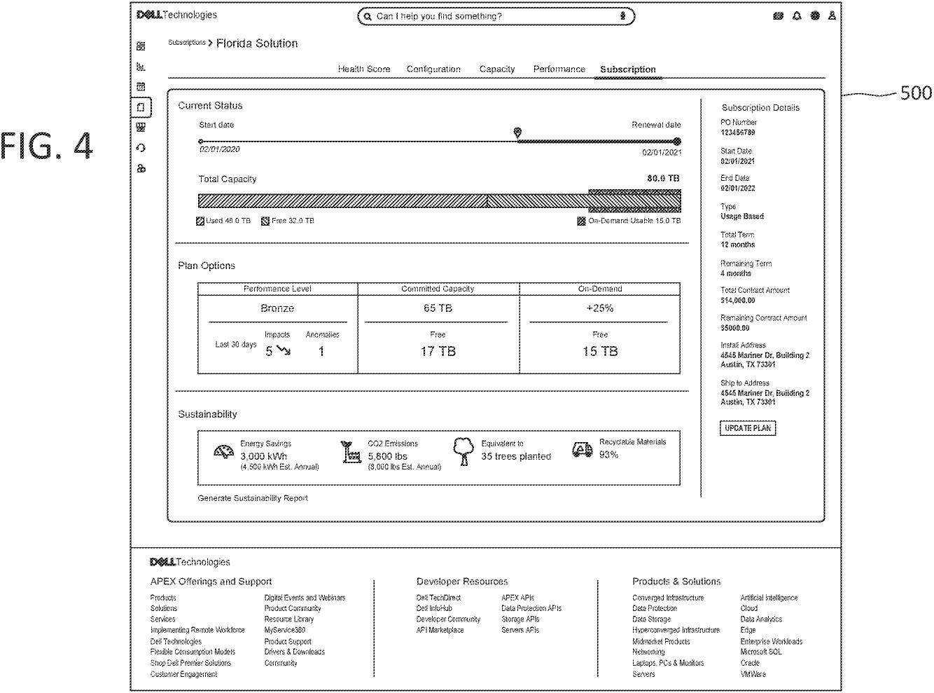

With reference finally to FIG. 4, data that was the basis for generation of the screens shown in FIGS. 2 and 3 may be used to build a baseline for reporting mechanisms. More specifically, FIG. 4 includes a screenshot 500 that displays elements of an example reporting mechanism for eWaste data. In the illustrated example, a user has requested subscription information, and the screenshot 500 displays information about the current status of the subscription, various plan options available to the user, and the sustainability impact in light of the current status. Various additional, or alternative, elements may be displayed.

### F. Example Methods

It is noted with respect to the example methods disclosed herein that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### G. Further Example Embodiments

Following are some further example embodiments of the invention. These are presented only by way of example and are not intended to limit the scope of the invention in any way.

Embodiment 1. A method, comprising: for an electronic asset that comprises hardware, creating an asset record that includes information about a physical configuration of the electronic asset and materials included in the electronic asset; entering the asset record in an eWaste tracing datastore; at an end of a useful life of the electronic asset, or a component within the asset, performing an inquiry to identify options for disposition of the asset or a component of the asset; receiving a user selection of one of the options; and based on the user selection, performing the selected option with respect to the electronic asset.

Embodiment 2. The method as recited in embodiment 1, wherein the asset record includes data from a bill of material for the electronic asset.

Embodiment 3. The method as recited in any of embodiments 1-2, wherein the selected option is one of: reclaiming a portion of the electronic asset; transferring the electronic asset to another entity; or, re-using the electronic asset.

Embodiment 4. The method as recited in any of embodiments 1-3, wherein the options are presented by virtue of their conformance with a sustainability standard.

Embodiment 5. The method as recited in any of embodiments 1-4, further comprising updating the eWaste tracing datastore after the selected option is performed.

Embodiment 6. The method as recited in any of embodiments 1-5, wherein the eWaste datastore comprises asset records for all electronic assets of an organization.

Embodiment 7. The method as recited in any of embodiments 1-6, wherein the eWaste datastore contains information concerning government regulations concerning disposition of electronic assets, and one of the options is based on the government regulations.

Embodiment 8. The method as recited in any of embodiments 1-7, wherein the eWaste datastore enables tracing of an electronic asset, and its components, throughout its service life.

Embodiment 9. The method as recited in any of embodiments 1-8, wherein the options are presented to a user by way of an interface that enables the user to view sustainability and other impacts of each particular option.

Embodiment 10. The method as recited in any of embodiments 1-9, wherein one of the options is presented based on a geofencing requirement.

Embodiment 11. A system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

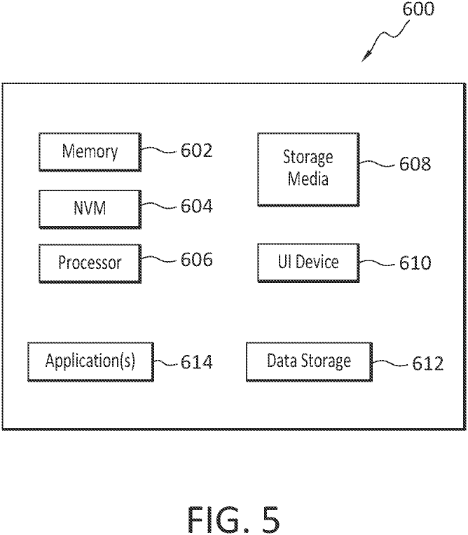

With reference briefly now to FIG. 5, any one or more of the entities disclosed, or implied, by FIGS. 1-4 and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 5.

In the example of FIG. 5, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
for an electronic asset that comprises hardware, creating an asset record that includes information about a physical configuration of the electronic asset and materials included in the electronic asset;
entering the asset record in an electronic waste tracing datastore;
at an end of a useful life of the electronic asset or a component within the asset, performing an inquiry to identify options for disposition of the electronic asset or the component of the electronic asset;
receiving a user selection of one of the options; and
based on the user selection, performing the selected option with respect to the electronic asset or the component of the electronic asset.

2. The method as recited in claim 1, wherein the asset record includes data from a bill of material for the electronic asset.

3. The method as recited in claim 1, wherein the selected option is one of: reclaiming a portion of the electronic asset; transferring the electronic asset to another entity; or, re-using the electronic asset.

4. The method as recited in claim 1, wherein the options are presented by virtue of their conformance with a sustainability standard.

5. The method as recited in claim 1, further comprising updating the electronic waste tracing datastore after the selected option is performed.

6. The method as recited in claim 1, wherein the electronic waste datastore comprises asset records for all electronic assets of an organization.

7. The method as recited in claim 1, wherein the electronic waste datastore contains information concerning government regulations concerning disposition of electronic assets, and one of the options is based on the government regulations.

8. The method as recited in claim 1, wherein the electronic waste datastore enables tracing of an electronic asset, and its components, throughout its service life.

9. The method as recited in claim 1, wherein the options are presented to a user by way of an interface that enables the user to view sustainability and other impacts of each particular option.

10. The method as recited in claim 1, wherein one of the options is presented based on a geofencing requirement.

11. A non-transitory storage medium having stored therein instructions that are executable by one or more hardware processors to perform operations comprising:
for an electronic asset that comprises hardware, creating an asset record that includes information about a physical configuration of the electronic asset and materials included in the electronic asset;
entering the asset record in an electronic waste tracing datastore;
at an end of a useful life of the electronic asset or a component within the asset, performing an inquiry to identify options for disposition of the electronic asset or the component of the electronic asset;
receiving a user selection of one of the options; and
based on the user selection, performing the selected option with respect to the electronic asset or the component of the electronic asset.

12. The non-transitory storage medium as recited in claim 11, wherein the asset record includes data from a bill of material for the electronic asset.

13. The non-transitory storage medium as recited in claim 11, wherein the selected option is one of: reclaiming a portion of the electronic asset; transferring the electronic asset to another entity; or, re-using the electronic asset.

14. The non-transitory storage medium as recited in claim 11, wherein the options are presented by virtue of their conformance with a sustainability standard.

15. The non-transitory storage medium as recited in claim 11, wherein the operations further comprise updating the electronic waste tracing datastore after the selected option is performed.

16. The non-transitory storage medium as recited in claim 11, wherein the electronic waste datastore comprises asset records for all electronic assets of an organization.

17. The non-transitory storage medium as recited in claim 11, wherein the electronic waste datastore contains information concerning government regulations concerning disposition of electronic assets, and one of the options is based on the government regulations.

18. The non-transitory storage medium as recited in claim 11, wherein the electronic waste datastore enables tracing of an electronic asset, and its components, throughout its service life.

19. The non-transitory storage medium as recited in claim 11, wherein the options are presented to a user by way of an interface that enables the user to view sustainability and other impacts of each particular option.

20. The non-transitory storage medium as recited in claim 11, wherein one of the options is presented based on a geofencing requirement.
